(19) United States
(12) Patent Application Publication
(10) Pub. No.: US 2026/0065514 A1
(43) Pub. Date: Mar. 5, 2026

(54) METHOD OF ENCODING/DECODING FEATURE

(71) Applicant: Electronics and Telecommunications Research Institute, Daejeon (KR)

(72) Inventors: Youn Hee KIM, Daejeon (KR); JooYoung LEE, Daejeon (KR); Se Yoon JEONG, Daejeon (KR); Jung Won KANG, Daejeon (KR)

(73) Assignee: Electronics and Telecommunications Research Institute, Daejeon (KR)

(21) Appl. No.: 19/311,153

(22) Filed: Aug. 27, 2025

(30) Foreign Application Priority Data
Aug. 28, 2024 (KR) 10-2024-0116077

(51) Int. Cl. G06T 9/00; G06T 3/4046

(52) U.S. Cl. CPC G06T 9/002; G06T 3/4046

(57) ABSTRACT

A method of encoding a feature according to the present disclosure may include converting a multi-layer feature to a single-layer feature; generating encoding data by transforming the single-layer feature; generating a 2-dimensional (2D) image based on the encoding data; and encoding the 2D image. In this instance, the encoding data may be generated by reducing channels or reducing a resolution of the single-layer feature.

### FIELD OF THE INVENTION

The present disclosure relates to a method of encoding/decoding a feature and device therefor.

### DESCRIPTION OF THE RELATED ART

Traditionally, image encoding/decoding technology has improved to enhance image compression efficiency and image quality by considering the human visual system. However, in the future, image encoding/decoding technology is expected to be widely used in the fields of machine vision such as surveillance, intelligent transportation, smart city, or intelligent industry as well as human vision.

Accordingly, the development of image encoding/decoding technology that may obtain high-efficiency compression and recognition accuracy by simultaneously considering human vision and machine vision is required.

### DISCLOSURE

### Technical Problem

The present disclosure is to provide a method of selecting a major unit from features and configuring data based on the selected major unit.

The present invention is to provide a method of selecting a major unit in units of channels or in units of components.

The present invention is to provide encode/decode information on a major unit.

The technical objects to be achieved by the present disclosure are not limited to the above-described technical objects, and other technical objects which are not described herein will be clearly understood by those skilled in the pertinent art from the following description.

### Technical Solution

A method of encoding a feature according to the present disclosure may include converting a multi-layer feature to a single-layer feature; generating encoding data by transforming the single-layer feature; generating a 2-dimensional (2D) image based on the encoding data; and encoding the 2D image. In this instance, the encoding data may be generated by reducing channels or reducing a resolution of the single-layer feature.

In the method of encoding a feature according to the present disclosure, reducing the channels of the single-layer feature represents removing a non-major channel from the single-layer feature.

In the method of encoding a feature according to the present disclosure, whether a current channel in the single-layer feature is a major channel or not is determined by comparing a component value, corresponding to the current channel, in an importance vector and a threshold value.

In the method of encoding a feature according to the present disclosure, the importance vector represents a gain unit vector.

In the method of encoding a feature according to the present disclosure, the gain unit vector is one of a plurality of gain unit vectors, and each of the plurality of gain unit vectors is learned for a corresponding bitrate.

In the method of encoding a feature according to the present disclosure, index information indicating one of the plurality of gain unit vectors is encoded.

In the method of encoding a feature according to the present disclosure, channels in the single-layer feature are rearranged with reference to a reference system, and information indicating a location of a last major channel among rearranged channels is encoded.

In the method of encoding a feature according to the present disclosure, reducing the resolution of the single-layer feature represents removing a non-major component in a current channel in the single-layer feature.

In the method of encoding a feature according to the present disclosure, a predetermined number of components with highest intensity value in the current channel are selected as a major component.

In the method of encoding a feature according to the present disclosure, mask information to distinguish a major component and a non-major component in the current channel is encoded.

In the method of encoding a feature according to the present disclosure, the mask information is encoded for each channel in the single-layer feature.

A method of decoding a feature according to the present disclosure may include decoding a 2-dimensional (2D) image; reconstructing encoding data based on the 2D image; restoring a single-layer feature based on the encoding data; and restoring a multi-layer feature based on the single-layer feature. In this instance, the single-layer feature may be obtained by increasing channels or increasing a resolution of the encoding data.

In the method of decoding a feature according to the present disclosure, the single-layer feature is obtained by concatenating a non-major channel to the encoding data.

In the method of decoding a feature according to the present disclosure, the non-major channel is generated by padding the non-major channel with a pre-defined value.

In the method of decoding a feature according to the present disclosure, increasing the resolution of the encoding data represents reconstructing a non-major component in a current channel in the encoding data, and a position of the non-major component in the current channel is determined based on mask information.

Meanwhile, according to the present disclosure, a computer readable recording medium recording instructions for executing the feature decoding method, instructions for executing the feature encoding method or a bitstream generated by the feature encoding method may be provided.

### Advantageous Effects

According to the present disclosure, an amount of data to be encoded/decoded may be reduced by selecting a major unit from features and configuring data based on the selected major unit.

According to the present disclosure, a method of selecting a major unit in units of channel units or in units of component units may be provided.

According to the present disclosure, by encoding/decoding information on a major unit, a method of reconstructing a feature having the same form as an original can be reconstructed at a decoder.

The effects provided by the present disclosure are not limited to the effects mentioned above, and other effects not mentioned will be clearly understood by a person having ordinary skill in the art to which the present disclosure pertains from the description below.

### BRIEF DESCRIPTION OF DRAWINGS

FIG. 1 is a diagram of a machine task processing system comprising a feature encoder and a feature decoder according to an embodiment of the disclosure.

FIG. 2 is a detailed configuration diagram of the feature encoder illustrated in FIG. 1.

FIG. 3 is a detailed configuration diagram of the feature decoder illustrated in FIG. 1.

FIGS. 4 and 5 illustrate examples of generating a multi-level feature group.

FIG. 6 illustrates an example of a single-layer feature being generated through feature fusion.

FIG. 7 is a flowchart of a method for generating encoding data based on a major unit.

FIG. 8 illustrates an entropy model for restoring an importance vector.

FIG. 9 is a flowchart of the process of generating encoding data from a single-layer feature.

FIG. 10 is a flowchart illustrating a process of selecting a major component for a single-layer feature.

FIG. 11 is a flowchart of a feature restoration method based on a major unit.

FIG. 12 illustrates candidate locations where major unit selection may be performed.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

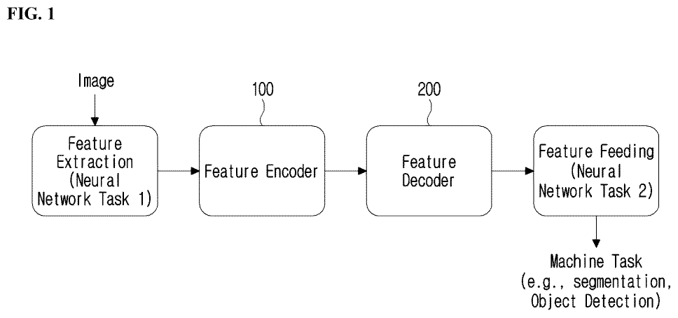

FIG. 1 is a diagram of a machine task processing system comprising a feature encoder and a feature decoder according to an embodiment of the disclosure.

Referring to FIG. 1, features are extracted from the input image according to a neural network task, and the extracted features are entered into the feature encoder 100.

The feature encoder 100 encodes the input features to generate a bitstream.

When the generated bitstream is transmitted to the feature decoder 200, the feature decoder 200 may decode the received bitstream and restore the features.

Meanwhile, based on the features restored from the video decoder (200), neural network tasks may be performed.

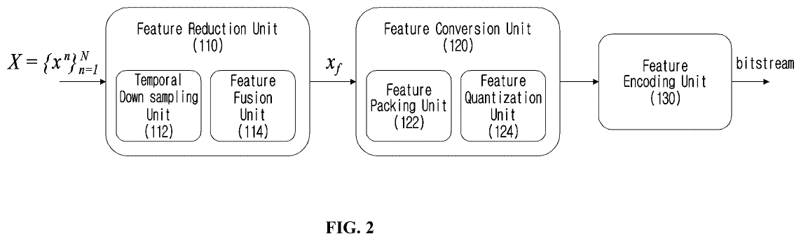

FIG. 2 is a detailed configuration diagram of the feature encoder illustrated in FIG. 1.

Referring to FIG. 2, the feature encoder 100 may include a feature reduction unit 110, a feature conversion unit 120, and a feature encoding unit 130.

The feature reduction unit 110 may perform temporal downsampling and feature fusion on input multi-layer feature. To this end, the feature reduction unit may comprise a temporal downsampling unit 112 and a feature fusion unit 114.

Here, the multi-lay feature may be composed of multiple layers. Each layer may be composed of at least one feature map. Meanwhile, one layer may be composed of multiple channels. That is, the number of channels for a specific layer may represent the number of feature maps belonging to the specific layer. Meanwhile, the value of an element (or pixel) within a feature map may be referred to as a feature value.

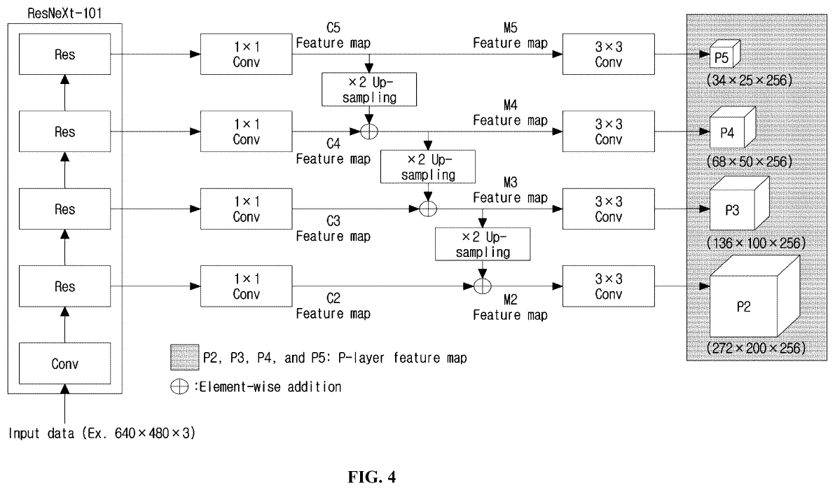

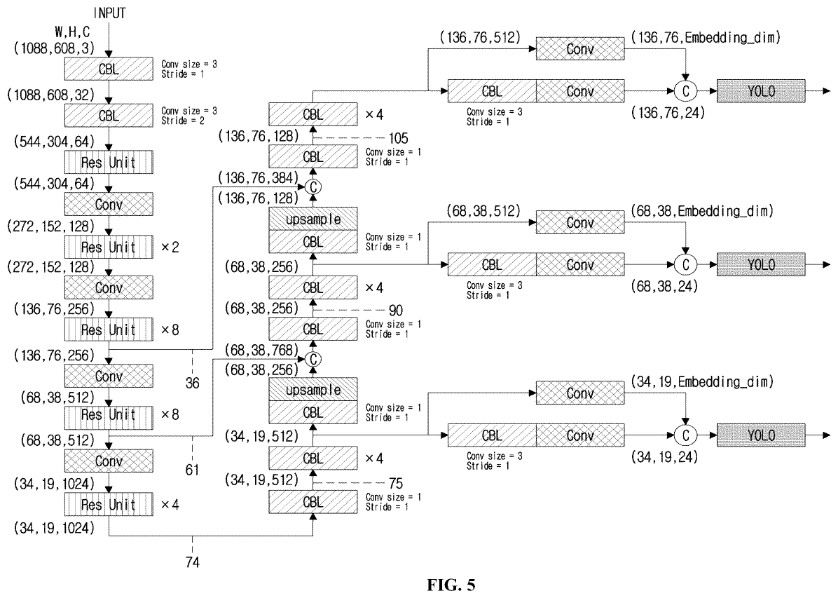

FIGS. 4 and 5 illustrate examples of generating a multi-level feature group.

An example, illustrated in FIG. 4, shows that a multi-layer feature consisting of multiple P-layers is generated through Faster/Mask R-CNN.

As in the example illustrated in FIG. 4, the PN layer may have the same number of channels as the P(N-1) layer, but a resolution thereof may be half of P(N-1) layer. That is, a width and a height of a features map included in PN layer may be half a width and a height of a feature map included in the P(N-1) layer, respectively. For example, the P2 layer may be a group of features of 256 channels with a size of 272×200, and the P3 layer may be a group of features of 256 channels with a size of 136×100.

An example, illustrated in FIG. 5, shows that a multi-layer feature consisting of multiple layers is generated through a JDE network.

Unlike the example illustrated in FIG. 5, the multi-layer feature generated via the JDE network may include L0 to L2 layers. In this case, the LN layer may have twice the number of channels compared to the L(N-1) layer, but a resolution thereof may be half of the L(N-1) layer. That is, a width and a height of a features map included in LN layer may be half a width and a height of a feature map included in the L(N-1) layer, respectively. For example, the L0 layer may be a group of features of 128 channels with a size of 136×76, and the L1 layer may be a group of features of 256 channels with a size of 68×38.

As in the examples shown in FIGS. 4 and 5, resolutions of each of the layers constituting the multi-layer feature may be different from each other, while the number of channels of each of the layers may be the same.

A temporal downsampling unit 112 may reduce the number of features to be encoded/decoded through temporal downsampling. That is, encoding/decoding may be omitted for some POCs through temporal downsampling. For example, odd-numbered images of a 60 fps (frame per second) video may be omitted to obtain a 30 fps video. Alternatively, images in a specific output order may be omitted in consideration of temporal redundancy between images.

A feature fusion unit 114 may fuse multi-layer feature into a single-layer feature. That is, feature fusion may reduce the number of layers to be encoded/decoded. By performing feature fusion on an input multi-layer feature, a single-layer feature composed of multiple channels may be generated.

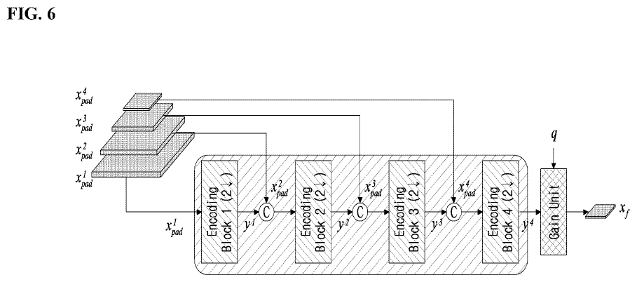

FIG. 6 illustrates an example of a single-layer feature being generated through feature fusion.

As shown in the example shown in FIG. 6, when a first layer feature map x¹_{pad} is input to an encoding block, a latent representation y¹ for a first layer is output. Subsequently, the latent representation y¹ of the first layer and a second layer feature map x²_{pad} are concatenated, and combined data may be input to an encoding block. In response to this input, a latent representation y² for the second layer may be obtained.

As shown above, by concatenating a latent representation y⁽ⁿ⁻¹⁾ of a previous layer (n-1) with a feature map xⁿ_{pad} of a current layer n and inputting combined data to an encoding block, a latent representation yⁿ for the current layer n may be obtained. By repeating this process up to the last layer, a latent representation for the last layer is obtained, and by inputting this latent representation for the last layer to the Gain Unit, a fused feature (i.e., a single-layer feature) x^{f} may be obtained. Meanwhile, the fused feature (i.e., the single layer feature) x^{f} may be a tensor data of three dimensions (i.e., C, W, H).

A feature conversion unit 120 converts the data output from the feature reduction unit 110 into a format suitable for encoding. For example, the feature conversion unit may perform feature packing and feature quantization.

That is, the feature conversion unit 120 may include a feature packing unit 122 and a feature quantization unit 124.

A feature packing unit may generate a single channel feature map by packing data output from the feature reduction unit 110 (i.e., a single layer feature) into a single frame. That is, through feature packing, data represented by 3 dimensions (i.e., channel, width, and height dimensions) may be converted into a feature map of a single channel represented by 2 dimensions (i.e., width and height dimensions). That is, a 2D feature map may be obtained by packing each channel of data output from the feature reduction unit 110 onto a 2D plane.

Meanwhile, when packing each of channels, a channel may be rotated or flipped.

A feature quantization unit 124 may perform linear quantization by using minimum and maximum values in a single channel feature map. Meanwhile, in order to perform inverse quantization in a feature decoder 200, the minimum and maximum values in the feature map may be encoded as metadata and transmitted. Through feature quantization, data with 32-bit floating point type may be converted into data with 10-bit integer type.

A feature encoding unit 130 encodes a quantized feature map. Encoding of the feature map may be based on a general codec technology such as VVC, HEVC, or AV1, or may be based on a codec technology based on a neural network.

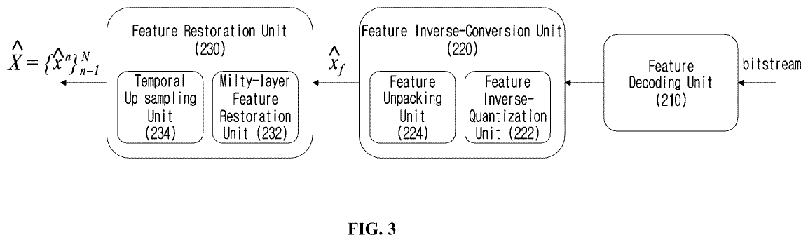

FIG. 3 is a detailed configuration diagram of the feature decoder illustrated in FIG. 1.

Referring to FIG. 3, the feature decoder 200 may include a feature decoding unit 210, a feature inverse conversion unit 220, and a feature restoration unit 230.

A feature decoding unit 210 decodes an encoded feature map. Decoding of a feature map may be based on a general codec technology such as VVC, HEVC, or AV1, or may be based on a codec technology based on a neural network.

A feature inverse conversion unit 220 may include a feature inverse quantization unit 222 and a feature unpacking unit 224.

A feature inverse quantization unit 222 performs inverse quantization on a decoded feature map. Specifically, inverse quantization on a decoded feature map may be performed based on minimum and maximum values in the feature map received from the feature encoder 100.

A feature unpacking unit 224 unpacks a single channel feature map to generate feature data having three dimensions with multiple channels (e.g., a single layer feature group). If a channel is packed into a feature map in a rotated or flipped state, the channel may be rotated or flipped in the opposite direction to generate a single layer feature.

A feature restoration unit 230 may comprise a muti-layer feature restoration unit 232 and a temporal upsampling unit 234.

A multi-layer restoration unit may restore a multi-layer feature from a single layer feature according to a machine task to be performed.

A temporal upsampling unit 234 may reconstruct an image at a time point where encoding/decoding was omitted from a restored multi-layer feature. For example, a multi-layer feature at a time point where encoding/decoding was omitted may be generated by interpolating multi-layer features at adjacent time points. Through temporal upsampling 234, a video at the same frame rate as multi-layer features input for encoding may be obtained.

Meanwhile, each functional unit (i.e., module) illustrated in FIGS. 2 and 3 may be implemented by a neural network, or may be implemented based on at least one of hardware and software. Meanwhile, the input/output data of each unit (i.e., module) may have a form of input/output data of a neural network.

Meanwhile, the present disclosure proposes a method of selecting at least one major unit from among multiple units and generating encoding data based on the selected major unit.

That is, instead of encoding/decoding all units, the encoding data may be configured with only a few major units that are sufficiently important to maintain machine task performance, thereby reducing the amount of data to be encoded/decoded while still maintaining task performance.

Meanwhile, in the present disclosure, a unit may correspond to a channel or a component (i.e., a pixel or a feature value).

Hereinafter, a feature encoding/decoding method based on unit selection according to the present disclosure will be described in detail.

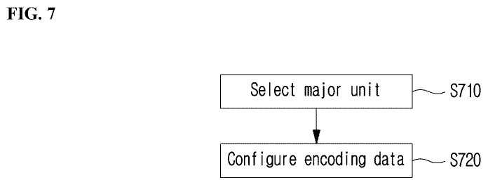

FIG. 7 is a flowchart of a method for generating encoding data based on a major unit.

An encoder may select at least one major unit S710. Here, the major unit may represent a unit selected as a target for encoding/decoding. In other words, the major unit may represent a encoding target unit or a decoding target unit. In the embodiments described below, the terms “encoding target unit” and “decoding target unit” may be used interchangeably.

A selection of a major unit may be performed on a multi-layer feature or a single-layer feature. The multi-layer feature may be input data to a temporal downsampling unit 112 or output data from the temporal downsampling unit 112. Meanwhile, the single-layer feature may be obtained through feature fusion.

A multi-layer feature or a single-layer feature may have a 3D feature, and the 3D feature may be composed of multiple channels. In this instance, selecting a major unit may represent selecting at least one of multiple channels as an encoding target.

Alternatively, selecting a major unit may represent selecting at least one of components constituting a specific channel as an encoding target.

Alternatively, selecting a major unit may represent a combination of the above two methods. That is, selecting a major unit may comprise selecting at least one of multiple channels and selecting at least one component within the selected channel.

Meanwhile, a reference value or reference system may be set for selecting a major unit. The reference value or reference system may represent at least one of an intensity value or an importance vector (or a component value of the importance vector).

For example, a reference value may be set as a threshold, and then whether to select a current unit as an encoding/decoding target may be determined based on whether the current unit is greater than or less than the threshold.

Alternatively, multiple units may be sorted in ascending or descending order according to a reference system, and then N units from the top or bottom may be selected as encoding targets. Here, N may be a natural number greater than or equal to 1.

Based on a major unit, encoding data may be constructed S720.

Meanwhile, encoding data may be generated from rearranged multi-layer feature or rearranged single-layer feature, in which multiple units are rearranged in ascending or descending order. After selecting a major unit from the rearranged multi-layer feature or rearranged single-layer feature, encoding data may be generated so that only the selected major unit remains.

That is, encoding data may be generated by converting either a multi-layer feature or a single-layer feature, depending on the selection target of the major unit.

For example, encoding data may be a data set including selected major units. That is, the encoding data may be generated by removing remaining units from a multi-layer feature or a single-layer feature, excluding the selected major units.

For example, if major units are selected in units of channels, encoding data may be generated by removing non-major channels from the multi-layer feature or single-layer feature. That is, the number of channels in the encoding data may be smaller than the number of channels in a multi-layer feature or a single-layer feature.

Alternatively, if major units are selected in units of components, encoding data may be generated by removing non-major components from the multi-layer feature or single-layer feature. Accordingly, a resolution of the feature map constituting the encoding data may be smaller than a resolution of the feature map constituting the multi-layer feature or single-layer feature.

Alternatively, construction of encoding data based on a major unit may be skipped. In this instance, a 2D image to be encoded/decoded may be generated from a multi-layer feature or single-layer feature in which channels are rearranged.

If encoding data is defined as a data set of selected major units, information indicating the number of selected major units may be encoded and signaled.

Alternatively, information on a position of a selected major unit may be encoded and signaled. The position information may indicate an index of the last selected major unit within a multi-layer feature or single-layer feature in which channels are rearranged. For example, if the top ten channels (i.e., from index 0 to index 9), based on a reference system, are selected from the rearranged channels, an index of the last selected channel (i.e., index 9) may be encoded and signaled. Here, the channel index may be reallocated one based on rearrangement of channels.

Based on encoding data, at least one of feature reduction and feature conversion may be further performed to generate a 2D feature map. After then, the 2D feature map may be encoded/decoded.

As another example, encoding data may be generated by converting values of remaining units, excluding selected major units, to a specific value. The specific value may be a predefined value, such as 0 or a threshold value. For example, if a major unit is selected in units of channels, encoding data may be generated by padding a non-major channel in a multi-layer feature or a single-layer feature with a specific value. Accordingly, the number of channels in the encoding data, au be the same as the number of channels in the multi-layer feature or the single-layer feature.

Alternatively, if a major unit is selected in units of components, encoding data may be generated by converting values of non-major components in a multi-layer feature or single-layer feature to a specific value. Accordingly, a resolution of a feature map constituting the encoding data may be the same as a resolution of a feature map constituting the multi-layer feature or the single-layer feature.

Along with encoding data, a mask may be further generated to indicate a selected major unit. The mask may be binary data used to distinguish between a major unit and a non-major unit. In other words, a position of the selected major unit within a channel may be specified through the mask. When encoding data is composed solely of selected major units by deleting non-major units from a feature map, the positions of the major units in the encoding data do not match those of the corresponding units in the feature map. To ensure positional correspondence, a mask may be generated and additionally encoded/decoded.

That is, the mask can be entropy-encoded and signaled together with the encoding data.

Based on the above explanation, an embodiment will first be described in which a major unit is selected in units of channels to generate encoding data.

### 1) Select Encoding/Decoding Target in Units of Channels

Whether a current channel is a major channel or not may be determined based on an intensity variation of feature values within the current channel. Here, the intensity variation may represent a variance of a channel. For example, if the variance of the current channel is greater than a threshold, the current channel may be selected as a major channel, i.e., an encoding target.

Alternatively, multiple channels may be rearranged in ascending or descending order by intensity variation, and then N channels may be selected from top or bottom. The selected N channels may be set as a major channel, i.e., an encoding target. Meanwhile, information indicating N may be encoded and signaled. This information may indicate the number of selected channels or the number of removed channels. Alternatively, this information may indicate an index of the last channel among the selected channels.

As another example, whether a current channel is a major channel or not may be determined based on an average intensity of feature values within the current channel. For example, whether the current channel is a major channel, i.e., encoding target channel, or not may be determined based on whether an average of the feature values for the current channel is greater than or equal to a threshold. If the average of the feature values for the current channel is greater than or equal to the threshold, the current channel may be selected as an encoding target. Conversely, if the average of the feature values for the current channel is less than the threshold, the current channel may not be selected as an encoding target.

Here, the threshold may be set to the average of the feature values for all channels. Alternatively, the encoder may set an arbitrary value as the threshold.

The encoder may encode and signal information regarding the threshold.

Alternatively, multiple channels may be rearranged in ascending or descending order based on average intensity, and then N channels from top or bottom may be selected. The selected N channels may be set as a major channel, i.e., encoding target channel.

As another example, the selection of encoding target channels may be based on an importance vector. Here, the importance vector may be obtained by learning.

A learned importance vector may include at least one of a gain unit vector, an inverse gain unit vector, or a channel importance map. Meanwhile, learning of the importance vector may be performed for each compression quality level (i.e., each bitrate). In other words, a learned importance vector may be present for each compression quality (i.e., each bitrate).

Alternatively, an importance vector may be restored from an entropy model.

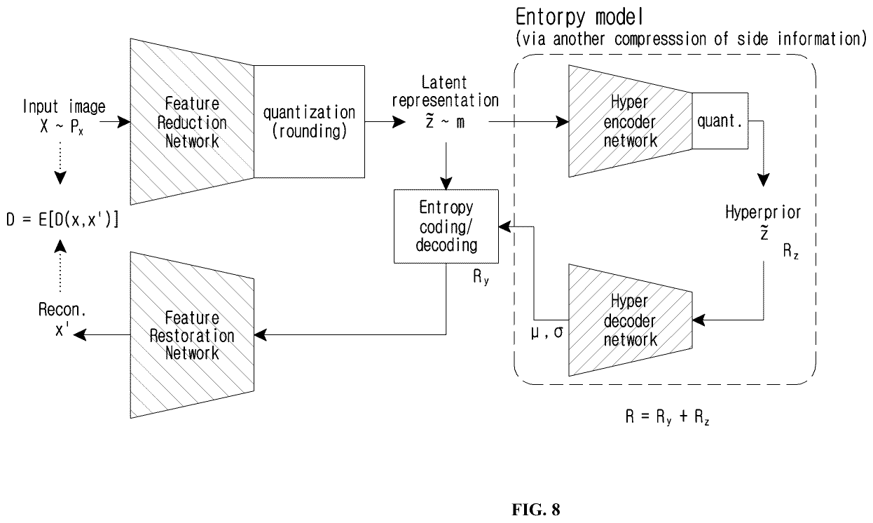

FIG. 8 illustrates an entropy model for restoring an importance vector.

An importance vector restored by an entropy model may include at least one of a restored variance, an average of each channel, or a channel importance map.

An importance vector may be composed of as many components as the number of channels. For example, a specific component of a gain unit vector may indicate an importance of a specific channel corresponding to the component.

Accordingly, whether a current channel is selected as a major channel, i.e., an encoding target channel, may be determined based on whether a component value of an importance vector corresponding to the current channel is greater than a threshold. For example, if the component value of the importance vector of the current channel is greater than the threshold, the current channel may be selected as the major channel, i.e., the encoding target channel.

An encoder may encode and signal information regarding the threshold value.

An importance vector may be determined based on a target bitrate. For example, if a gain unit vector is learned for each compression quality (i.e., bitrate), a gain unit vector used to select an encoding target unit may vary depending on the target bitrate. That is, whether to set the current channel as a major channel may be determined based on a gain unit vector corresponding to a target bitrate.

Alternatively, two gain unit vectors may be interpolated, and an encoding target unit may be selected based on an interpolated value. For example, if a learned gain unit vector corresponding to a target bitrate (i.e., encoded bitstrate) does not exist, a gain unit vector learned for a bitrate lower than the target bitrate and a gain unit vector learned for a bitrate higher than the target bitrate may be interpolated to obtain an interpolated gain unit vector. Thereafter, whether to set a current channel as a major channel or not may be determined based on the interpolated gain unit vector.

Alternatively, multiple channels may be rearranged in ascending or descending order by an importance vector, and then N channels may be selected from top or bottom. The selected channels may be set as encoding targets.

Meanwhile, in the above-described embodiments, information indicating the number N of selected channels may be encoded and signaled. The information may indicate the number of selected channels or the number of removed channels. Alternatively, the information may indicate an index of the last channel among the selected channels.

Alternatively, among factors enumerated above, multiple factors may be combined for selecting an encoding target channel.

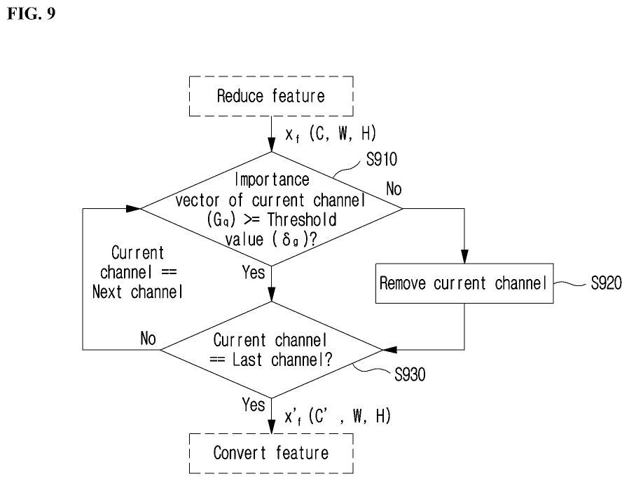

FIG. 9 is a flowchart of the process of generating encoding data from a single-layer feature.

In the example illustrated in FIG. 9, a single-layer feature x¹ may be 3D (i.e., C, W, H) tensor data. For convenience of explanation, it is assumed that a major channel is determined based on a value Gq of a gain unit vector for each channel. Here, Gq may represent a component value of a gain unit vector of a corresponding channel.

Meanwhile, a value Gq of the gain unit vector for each channel may be used for feature reduction in an encoder. Furthermore, a decoder may also perform feature restoration using a gain unit vector Gq of each channel. In other words, a value Gq of the gain unit vector for each channel may exist not only in the encoder but also in the decoder. When a gain unit vector is obtained for each bitrate, index information indicating one of multiple gain unit vectors may be encoded and signaled. Additionally, information indicating a threshold value may also be encoded and signaled.

A gain unit vector value Gq of a current channel may be compared with a threshold value δ_{g} to determine whether the current channel is to be set as a major channel S910. For example, if the gain unit vector value Gq of the current channel is greater than or equal to the threshold value δ_{g}, the current channel may be set as the major channel, i.e., a channel to be encoded. Conversely, if the gain unit vector value Gq of the current channel is less than the threshold value δ_{g}, the current channel may not be set as the primary channel, i.e., the channel to be encoded. If the current channel is not the major channel, the current channel may be removed while obtaining encoding data S920. The above process may be repeatedly performed for all channels S930.

If a gain unit vector exists for each bitrate, the gain unit vector corresponding to a target bitrate (or quantization parameter) may be used to determine whether to set a current channel as a major channel.

Furthermore, index information indicating one of multiple gain unit vectors may be encoded and signaled so that a decoder could utilize the same gain unit vector. Furthermore, information indicating a threshold value may also be encoded and signaled.

Encoding data may be obtained by deleting non-major channels from a single-layer feature. That is, the encoding data may be a single-layer feature with a reduced number of channels. Meanwhile, a resolution (i.e., W×H) of the encoding data may be the same as that of the single-layer feature.

Unlike the example described above, encoding data may be generated by converting feature values within non-major channels to specific values in a single-layer feature. In this case, the encoding data may consist of the same number of channels as the single-layer feature. That is, the encoding data may be a single-layer feature with non-major channels transformed.

Once encoding data is generated, feature conversion may be performed on encoding data to generate a 2D image. Specifically, each channel constituting encoding data may be packed onto a 2D plane to generate a 2D image.

While FIG. 9 illustrates that encoding data is generated from a single-layer feature, it is also possible to generate encoding data from a multiple-layer feature. In this case, a feature reduction process may be additionally performed on encoding data to convert the encoding data into a single-layer feature.

Next, we will examine in detail the method of selecting encoding targets in units of components in a channel.

### 2) Select Encoding/Decoding Target in Units of Components in a Channel

A component to be encoded in a channel may be selected based on an intensity value of feature values. Here, the intensity value may represent at least one of a mean or variance of feature values in the channel. For example, after setting a threshold, a component equal to or greater than the threshold value in the channel may be selected as a major component, i.e., encoding target component.

Alternatively, a component smaller than the threshold value in the channel may be selected as a major component.

Alternatively, multiple thresholds may be defined and a major component may be selected based on these thresholds. For example, a component within the range between the first and second threshold values may be selected as a major component, i.e., encoding target component. Alternatively, the remaining components, excluding components within the range between the first and second threshold values, may be selected as a major component, i.e., encoding target component.

Alternatively, N components may be selected in order of large feature values or in the order of smaller feature values in the channel, and the selected components may be set as encoding targets.

As another example, a major component in a channel may be selected based on an importance vector.

As described above, an importance vector may be obtained through learning. For example, the learned importance vector may include at least one of a gain unit vector or an inverse gain unit vector.

Alternatively, an importance vector may be obtained through a transformation. Here, the transformation may include at least one of a Picture Component Analysis (PCA) transformation, a Discrete Cosine Transform (DCT), or a Discrete Sine Transform (DST).

For example, a component in a channel whose an importance vector is greater than or less than a threshold may be selected as encoding target.

Alternatively, N components within the channel can be selected in the order of larger importance vector, and the selected components may be set as encoding targets.

As described above, the selection of a major unit may be performed based on at least one of an intensity value or an importance vector.

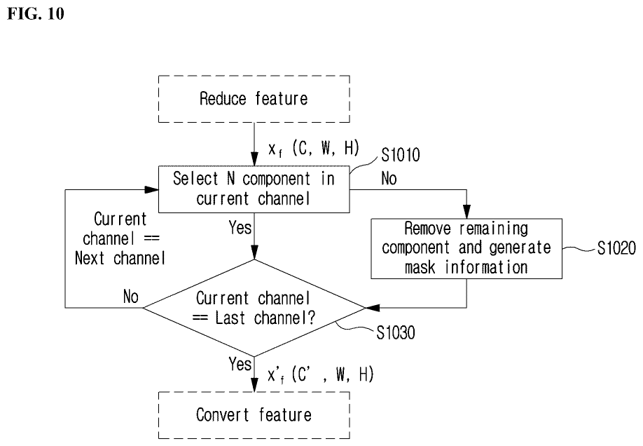

FIG. 10 is a flowchart illustrating a process of selecting a major component for a single-layer feature.

In the example illustrated in FIG. 10, the single-layer feature x′ may be 3D (i.e., C, W, H) tensor data. For convenience of explanation, it is assumed that N components with high intensity values in a channel are set as major components, i.e., encoding targets.

N elements with high intensity values in a current channel may be set as encoding targets S1010. Subsequently, a mask M may be generated to identify the N elements on the current channel S1020.

The mask M may be defined as in the following equation 1.

$$M = {\sum }_{i = 0}^{c - 1} mi \qquad [ Equation 1 ]$$

Furthermore, encoding data may be generated by removing non-major units, excluding major units in the current channel S1020. Accordingly, a resolution (w′×h′) of channels within the encoding data may be less than or equal to a resolution (w×h) of channels in a single-layer feature (i.e., w>=w′, h>=h′). In other words, the encoding data may be a single-layer feature with reduced resolution.

Meanwhile, the above process may be repeatedly performed for all channels S1030.

While FIG. 10 illustrates a generation of encoding data from a single-layer feature, it is also possible to generate encoding data from a multi-layer feature. In this case, a feature reduction process may be additionally performed on the encoding data to convert the encoding data into a single-layer feature.

Furthermore, the embodiments of FIGS. 9 and 10 may be combined. For example, selection of a major channel may first be performed in units of channels, and then selection of a major component in the selected major channel may be performed secondarily. Ultimately, encoding data may include only major components in selected major channels.

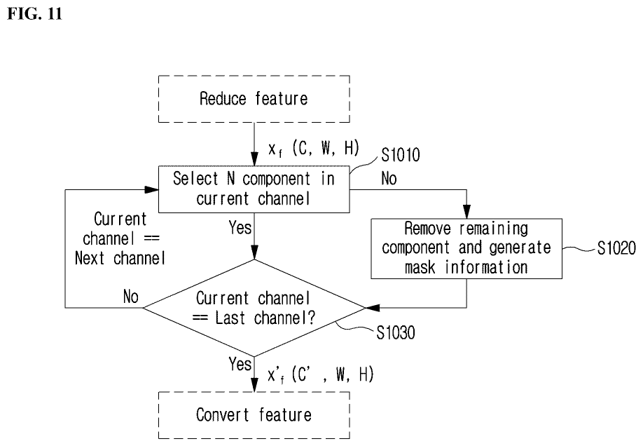

FIG. 11 is a flowchart of a feature restoration method based on a major unit.

The decoder restores encoding data S1110 and, based on information regarding selection of a major unit, reconstructs features from the encoding data S1120.

Specifically, a 2D image is decoded, and then an inverse feature conversion is performed on the 2D image so that the encoding data is restored. Alternatively, the encoding data may be restored by performing multi-layer feature restoration on a reconstructed single-layer features obtained by an inverse feature conversion.

A restored feature may be a single-layer feature or a multi-layer feature, depending on where encoding data was generated. The multi-layer features may be obtained before or after temporal upsampling. For example, if encoding data is generated by removing non-major channels, as in the example illustrated in FIG. 9, the reconstructed encoding data does not comprise data of the non-major channels. Accordingly, the decoder should reconstruct the non-major channels by itself, and then combine (i.e., concatenate) the reconstructed encoding data with the reconstructed non-major channels to reconstruct the feature. In other words, restoring the feature may represents increasing the number of channels in the reconstructed encoding data.

Meanwhile, the decoder may reconstruct a non-major channel by filling it with a specific value.

Alternatively, the decoder may reconstruct a non-major channel by interpolating the major channels adjacent to the non-major channel.

For example, as in the example illustrated in FIG. 10, if encoding data is generated by removing non-major components, reconstructed encoding data may comprise only major components. The decoder may restore the feature map by shifting the major components in the encoded data back to their original positions in the feature map based on a mask and by padding the non-major components in the feature map with a specific value. In other words, restoring a feature may represent increasing a resolution of a channel in the reconstructed encoding data.

Alternatively, the decoder may interpolate major components adjacent to a non-major component to restore a value of the non-major component.

Meanwhile, if channel rearrangement has been performed for a single-layer feature or a multi-layer feature, inverse rearrangement may be performed to restore the rearranged channels to their original order. For example, if the channels were rearranged by the encoder based on a gain unit vector, the decoder may restore original orders of channels based on an inverse gain unit vector.

To reconstruct a feature from encoding data, information on a major unit may be encoded/decoded. Information on a major unit may include at least one of the following: information on a unit for a major unit selection, information on a reference value or reference system used for selection of a major unit, information indicating a location/number of selected major units, or information indicating a compression type of a major unit.

Information on a reference value or reference system used for selection of a major unit may include at least one of an importance vector or a threshold value.

Information indicating a location/number of selected major units may include at least one of information indicating the number of selected major channels or information indicating the number of selected major components elements in a channel. Alternatively, instead of information indicating the number of selected major units, information indicating the number of units that were not selected and deleted may be encoded/decoded. Furthermore, to reduce the amount of data to be encoded/decoded, a value that is the difference of a predefined number from that number may be encoded/decoded. Here, the predefined number may be a natural number, such as 1 or 2.

Alternatively, information indicating a location/number of a selected major unit may be information indicating an index of the last channel among the selected channels.

Information indicating a compression type of a major unit may be an index (or flag) indicating one of multiple compression type candidates. For example, the compression type candidates may include at least one of removing non-major units excluding major units or transforming non-major units to a specific value.

Tables 1 to 3 illustrate syntax structures including information on a major unit.

TABLE 1

| | Descriptor |
|---|---|
| | (in bits) |
| sequence_parameter_set ( ) { | |
| ... | |
| channel_unit_reduction_apply | u(1) |
| if (channel_unit_reduction_apply) { | |
| channel_unit_reduction_period | u(8) |
| } | |
| component_unit_reduction_apply | u(1) |
| if (component_unit_reduction_apply) { | |
| component_unit_reduction_period | u(8) |
| } | |
| ... | |
| } | |

TABLE 2

| | Descriptor(in |
|---|---|
| | bits) |
| picture_parameter_set ( ) { | |
| ... | |
| if (channel_unit_reduction_apply && (poc % | |
| channel_unit_reduction_period) == 0) { | |
| g_index | f(32) |
| th_g_value | f(32) |
| } | |
| ... | |
| } | |

TABLE 3

| | Descriptor(in |
|---|---|
| | bits) |
| picture_parameter_set ( ) { | |
| ... | |
| if (component_unit_reduction_apply&& (poc % | |
| component_unit_reduction_period) == 0) { | |
| for (i=0; i<=num_of_layers_in_ft; i++) { | |
| for (j=0; j<=num_of_channel; j++) { | |
| selection_mask[i][j] | u(1) |
| } | |
| } | |
| } | |
| ... | |
| } | |

In Table 1, the syntax channel_unit_reduction_apply may be a flag indicating whether selection of a major unit was performed in units of channels.

If the syntax channel_unit_redunction_apply indicates that the selection of a major unit was performed in units of channels, the syntax channel_unit_reduction_period may be additionally encoded/decoded. The syntax channel_unit_reduction_period may specify the duration over which a reference value or reference system is applied when selecting a major unit in units of channels. For example, a threshold value may remain effective for the period indicated by channel_unit_reduction_period.

Meanwhile, although not exemplified in the above tables, information indicating whether a current channel is a deleted channel may be encoded/decoded in units of channels. This information may be a 1-bit flag. For example, a value of 0 for the flag indicates that the current channel is a deleted channel. In this case, the decoder may restore the current channel according to a predefined method. On the other hand, a value of 0 for the flag indicates that the current channel is not a deleted channel. In this case, the channel decoded from the bitstream may be set as the current channel.

The syntax component_unit_reduction_apply may be a flag indicating whether selection of a major unit was performed in units of components.

If the syntax component_unit_redunction_apply indicates that selection of a major unit was performed in units of components, the syntax component_unit_reduction_period may be additionally encoded/decoded. The syntax component_unit_reduction_period may specify the duration over which a reference value or reference system is applied when selecting a major unit in units of components. For example, a threshold value may remain effective for the period indicated by the component_unit_reduction_period.

In Table 2, the syntax g_index may indicate an index of a gain unit vector. For example, if there are gain unit vectors for a plurality of bitrates, the syntax g_index may indicate one of multiple gain unit vectors. The decoder may reconstruct a feature based on an inverse gain unit vector corresponding to the syntax g_index.

The syntax th_g_value may indicate a threshold for a gain unit vector value.

Meanwhile, instead of the syntax th_g_value, information on the position/number of selected channels may be encoded/decoded. For example, information indicating an index of the last channel among the selected channels may be encoded/decoded.

Meanwhile, the syntax g_index and syntax th_g_value in Table 2 may be encoded/decoded when selection of a major unit is performed in units of channel (i.e., when channel_unit_reduction_apply is 1). Additionally, the syntax g_index and syntax th_g_value may be encoded/decoded only for the first picture in the period to which a reference value is applied (i.e., the picture for which the modulo (%) operation between the POC (Picture Order Counter) value thereof and the channel-unit_reduction_period value is 0).

In Table 3, the syntax num_of_layers_in_ft indicates the number of feature layers to be reconstructed from encoding data. For example, if a feature to be reconstructed is a single-layer feature, num_of_layers_in_ft may indicate one. Conversely, if the feature to be reconstructed is a multi-layer feature, num_of_layers_in_ft may indicate multiple layers.

The syntax selection_mask[i] [j] may represent a mask for a j-th channel in an i-th layer. The mask may be encoded and signaled for each channel.

Meanwhile, the syntax selection_mask in Table 3 may be encoded/decoded when selection of a major unit is performed in units of components (i.e., when component_unit_reduction_apply is 1). Furthermore, the syntax selection_mask may only be encoded/decoded for the first picture in the period to which the reference value or reference system is applied (i.e., the picture for which the modulo (%) operation between the POC (Picture Order Counter) value thereof and component_unit_reduction_period is 0).

Furthermore, information indicating a location where a major unit selection was performed may be encoded and signaled. This information may be an index indicating one of the candidate locations where a major unit selection is performed.

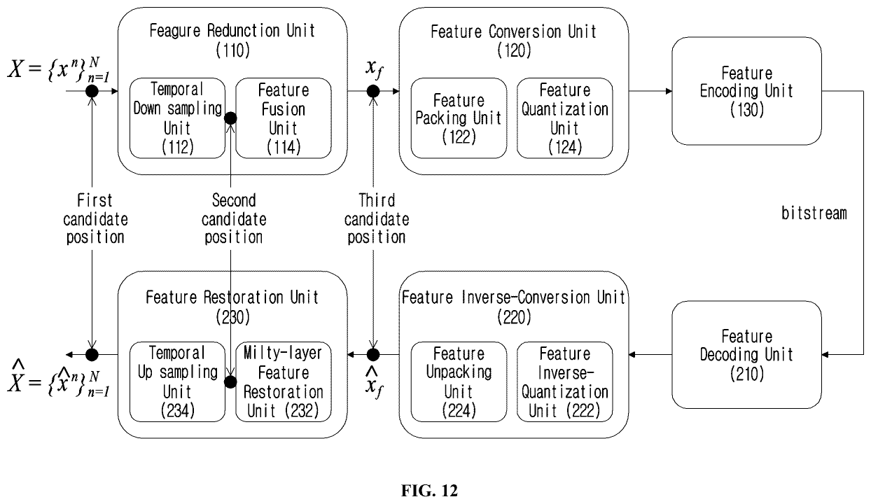

FIG. 12 illustrates candidate locations where major unit selection may be performed.

As illustrated in the example shown in FIG. 12, selection of a major unit and generation of encoding data may be performed on data input to the feature reduction unit (i.e., multi-layer feature), temporally downsampled data (i.e., temporally downsampled multi-layer feature), or data obtained through feature fusion (i.e., single-layer feature).

Alternatively, a flag may be encoded and signaled for at least one candidate location where selection of a major unit can be performed. For example, at least one of a flag indicating whether selection of a major unit was performed on a multi-layer feature, a flag indicating whether selection of a major unit was performed on a temporally downsampled multi-layer feature, or a flag indicating whether selection of a major unit selection was performed on a single-layer feature may be encoded and signaled.

The decoder may reconstruct a feature based on reconstructed encoding data at locations corresponding to the locations where encoding data was generated. Here, the feature may represent a multi-layer feature or a single-layer feature, depending on where the encoding data is generated.

For example, if the encoder selects a major unit for a single-layer feature obtained through a feature fusion, the decoder may reconstruct the single-layer feature by reconfiguring the data input to the multi-layer feature reconstruction unit.

Alternatively, if the encoder selects a major unit for a temporally downsampled multi-layer feature, the decoder may reconstruct the temporally downsampled multi-layer feature by reconfiguring the data input to a temporal upsampling unit.

Alternatively, if the encoder selects a major unit for a multi-layer feature, the decoder may reconstruct the multi-layer feature by reconfiguring data output from the temporal upsampling unit.

As another example, information indicating where major unit selection was performed may be a flag indicating whether a major unit was selected for a specific data set.

Meanwhile, if rearrangement of channels is performed for a multi-layer feature or a single-layer feature, information for restoring the rearranged channels to their original order may be additionally encoded/decoded.

For example, information indicating whether rearrangement of channels was performed for a multi-layer feature or a single-layer feature may be encoded/decoded. This information may be a 1-bit flag.

If the flag indicates that rearrangement of channels was performed, information indicating an original order (i.e., an original index) of a current channel may be additionally encoded/decoded. Based on this decoded information, an index of the current channel may be changed to the original index.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of encoding a feature, comprising:
converting a multi-layer feature to a single-layer feature;
generating encoding data by transforming the single-layer feature;
generating a 2-dimensional (2D) image based on the encoding data; and
encoding the 2D image,
wherein the encoding data is generated by reducing channels or reducing a resolution of the single-layer feature.

2. The method of claim 1, wherein reducing the channels of the single-layer feature represents removing a non-major channel from the single-layer feature.

3. The method of claim 2, wherein whether a current channel in the single-layer feature is a major channel or not is determined by comparing a component value, corresponding to the current channel, in an importance vector and a threshold value.

4. The method of claim 3, wherein the importance vector represents a gain unit vector.

5. The method of claim 4, wherein the gain unit vector is one of a plurality of gain unit vectors, and
wherein each of the plurality of gain unit vectors is learned for a corresponding bitrate.

6. The method of claim 5, wherein index information indicating one of the plurality of gain unit vectors is encoded.

7. The method of claim 1, wherein channels in the single-layer feature are rearranged with reference to a reference system, and
wherein information indicating a location of a last major channel among rearranged channels is encoded.

8. The method of claim 1, wherein reducing the resolution of the single-layer feature represents removing a non-major component in a current channel in the single-layer feature.

9. The method of claim 8, wherein a predetermined number of components with highest intensity value in the current channel are selected as a major component.

10. The method of claim 9, wherein mask information to distinguish a major component and a non-major component in the current channel is encoded.

11. The method of claim 1, wherein the mask information is encoded for each channel in the single-layer feature.

12. A method of decoding a feature, comprising:
decoding a 2-dimensional (2D) image;
reconstructing encoding data based on the 2D image;
restoring a single-layer feature based on the encoding data; and
restoring a multi-layer feature based on the single-layer feature,
wherein the single-layer feature is obtained by increasing channels or increasing a resolution of the encoding data.

13. The method of claim 12, wherein the single-layer feature is obtained by concatenating a non-major channel to the encoding data.

14. The method of claim 13, wherein the non-major channel is generated by padding the non-major channel with a pre-defined value.

15. The method of claim 12, wherein increasing the resolution of the encoding data represents reconstructing a non-major component in a current channel in the encoding data, and
wherein a position of the non-major component in the current channel is determined based on mask information.

16. A non-transitory computer readable medium storing instructions when executed cause the computer to carry out a method of encoding a feature which comprising:
converting a multi-layer feature to a single-layer feature;
generating encoding data by transforming the single-layer feature;
generating a 2-dimensional (2D) image based on the encoding data; and
encoding the 2D image,
wherein the encoding data is generated by reducing channels or reducing a resolution of the single-layer feature.
